(19) United States
(12) Patent Application Publication
(10) Pub. No.: US 2006/0026879 A1
(43) Pub. Date: Feb. 9, 2006

(54) Label supporting frame device, for pictures, for cards and the like, to be applied to bottles and vessels

(76) Inventor: Alessandro Tebaldi, Valeggio Sul Mincio Verona (IT)

Correspondence Address: HEDMAN & COSTIGAN P.C., 1185 AVENUE OF THE AMERICAS, NEW YORK, NY, 10036, US

(21) Appl. No.: 10/936,409

(22) Filed: Sep. 7, 2004

(30) Foreign Application Priority Data
Aug. 4, 2004 (IT) MI 2004 A 001605

(51) Int. Cl. G09F 3/00

(52) U.S. Cl. 40/760; 40/310

(57) ABSTRACT

A device for providing a support frame for labels, pictures, cards and the like, to be applied to bottles and vessels in general, characterized in that said device comprises a frame which can be applied to a surface of a vessel by clamping means and a plate element which can be arranged between the frame and the vessel surface and bearing information, decorations and images, which can be seen from the outside. The frame can be made of silver or other material, metal, plastics material, paperboard, wood, ceramics, and being of a suitable configuration and shape, either with or without support elements. The frame can be applied on bottles to underline an image, greeting, picture and distinctive an event of an advertising action to be performed.

### BACKGROUND OF THE INVENTION

The present invention relates to a device adapted to operate as a supporting frame for labels, pictures, cards and the like, to be applied to bottles and vessels in general.

A wine bottle, a sparkling wine bottle, a grappa bottle or an oil bottle, perfume and essential oil vial constitute, as is well known, an agreeable present for providing, in a personal manner, a message, with a pleasant evidence affecting several senses, of a season or time period.

With respect to other presents, such as plants, flowers, food and the like, which have a much or more long life and a different aesthetic visibility in an environment, such as a home, the bottles have a different communication value, i.e. an agreeable image value, since they could also constitute a part of the furnishings.

In this connection, please make reference to the exposed to view bottle cabinets, bar furniture pieces, liqueur trays and the like.

Actually, the message of a bottle is that of an absolutely visual “packaging”, related to the packaging method and corresponding trade-marks.

However, if such a condition for value products represents an additional value and certifies the exclusivity of the product, it, in the meanwhile, weakens or nullifies the causal connection or nexus between the present and the giver thereof.

This would be for example true for a company gift strategy, the main object thereof, in addition to the gift selection, would be that of a “corporate” communication.

Even in a private environment, some bottles, in particular wine, sparkling wine or alcohol bottles, contradistinguish and underline in the time some life significative moments, such as the achievement of a degree, a marriage, a child birthday and so on.

This time marking function, of an object preserved as a memory of a particular time period, is related to the present or gift buying or receiving moment, the time coincidence of the bottling year as shown on the label, for example for a birthday, or to an association and pouring made at an event date, for example a marriage reception of party.

### SUMMARY OF THE INVENTION

Accordingly, the aim of the present invention is to provide a device specifically designed for operating as a supporting frame for labels, pictures, cards or the like, to be applied to bottles, and adapted to associate the commemorative and distinctive value of the vessel and packaging to a customizing need for participating in the event, for which the bottle has been designed.

Within the scope of the above mentioned aim, a main object of the present invention is to provide such a device which can be used for vessels for holding either food products or not food products, such as wines, liqueurs, beverages, alimentary oils and preparations, perfumes, essential substances, essential oils, mineral salts and the like.

Yet another object of the present invention is to provide such a support device which can be applied to any desired types of bottles and vessels in general.

According to one aspect of the present invention, the above mentioned aim and objects, as well as yet other objects, which will become more apparent hereinafter, are achieved by a support device, specifically designed for bottles and vessels in general, characterized in that said support device comprises a frame which can be applied to a surface of the vessel by clamping means and a plate element adapted to be arranged between said frame and vessel surface and bearing information, decorations and images, which can be seen from the outside.

### BRIEF DESCRIPTION OF THE DRAWINGS

Further characteristics and advantages of the present invention will become more apparent hereinafter from the following detailed disclosure of a preferred, though not exclusive, embodiment of the invention, which is illustrated, by way of an indicative but not limitative example, in the accompanying drawings, where:

FIG. 1 is a front perspective view of a bottle including the frame supporting device according to the present invention;

FIG. 2 is a side elevation view, on an enlarged scale with respect to FIG. 1 and in cross-section, showing the frame supporting device according to the invention;

FIG. 3 is an exploded perspective view of the frame supporting device according to the invention applied to the bottle of the preceding figures;

FIG. 4 is a further front perspective view illustrating an operating step for applying the frame device according to the invention;

FIG. 5 is a front elevation view illustrating a construction of the device according to the invention;

FIG. 6 is a rear elevation view of the construction of the device according to the invention; and

FIGS. 7-9 show some possible embodiments of the construction of the device according to the present invention designed for application to bottles or other vessels or containers.

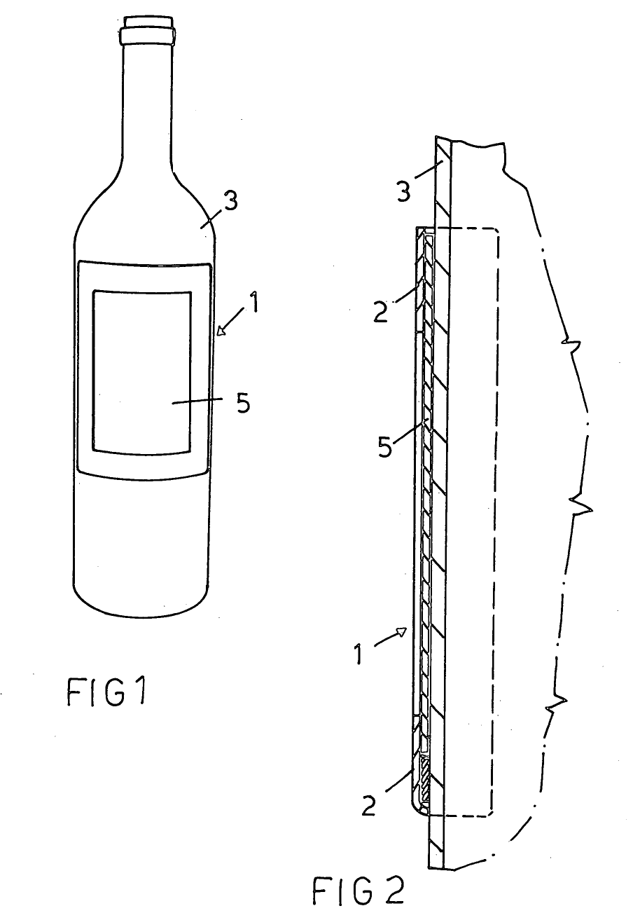

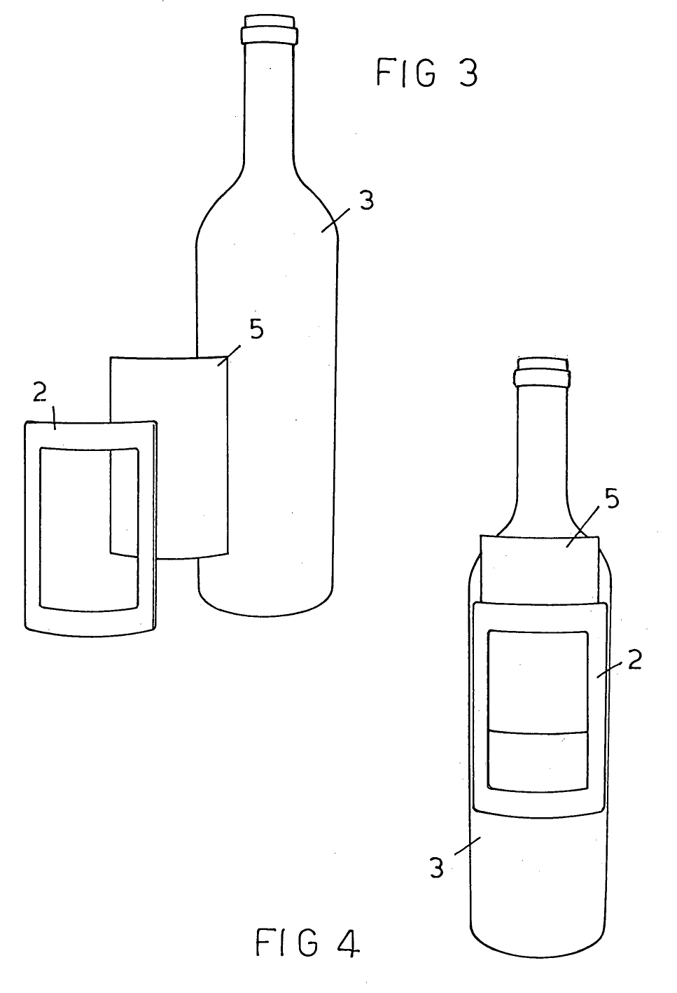

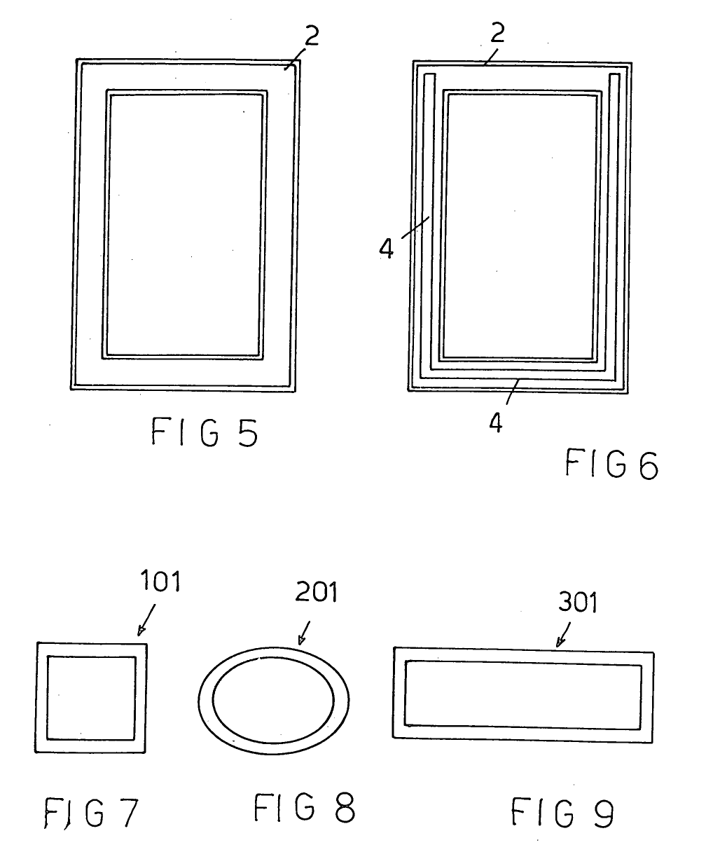

### DESCRIPTION OF THE PREFERRED EMBODIMENTS

With reference to the number references of the above mentioned figures, the frame support device construction according to the present invention, which has been generally indicated by the reference number 1, comprises a frame 2 which can be applied to the outer surface of a vessel or container, such as a bottle 3, by clamping means either removable or not, according to requirements.

More specifically, said clamping means can comprise glue or a biadhesive strip 4, as in the example shown in the figures.

Between the frame 2 and the surface of the vessel 3 is arranged a sheet or plate element 5, bearing information, decorations, pictures and images as typically found on a label.

Said frame can be made in several configurations and materials, depending on the communication and making requirements.

For making it, metals, even precious metals, or laminated or solid metals can be used, to provide a desired shape or configuration, and it would be also possible to use plastics materials, ceramics, wood, paperboard, glass materials and the like.

The frame can be made either on a small series or on an industrial or large series.

More specifically, the frame 2 can have different shapes and configurations, in addition to a nearly infinite range of punchings, embossed arrangements, incisions, decorations and so on.

The size of the frame 2 will vary depending on the contents, configuration and size of the bottle, picture or card to be associated and depending on the importance or value to be given to the finished package.

The shape, in particular, can be that of a conventional label, i.e. rectangular, square, oval, enveloping, or sheet element coating the bottle such as a creeping plant, a flower ornament, a tie or papillon, with a dedicated case for engaging therein a picture or card 5.

The device according to the present invention can be made of a series of different pieces, to be periodically distributed for collection purposes.

Between the frame 2 and bottle it would be possible to engage a suitable casing, made of a cardboard or semi-rigid plastic material, rigid with the frame, to facilitate the engaging of the picture or card 5 in the frame 2, for protective purposes.

For a curved shape bottle, the concave profile of the construction will provide said construction with self-supporting or standing capability, and, for a detachment from the bottle, it will provide a very easy operation, such as that of a conventional ornamental articles.

In the case of a square cross-section bottle, or a flat-side bottle, it would be also possible to provide a retractable fin, mounted on the frame as a picture bearing casing arrangement.

The detachment characteristic of the device is made possible by glueing or clamping by adhesive materials or removable elements.

The detachment capability of the present device adds a further value to the present or gift, allowing the frame to be preserved separated from the bottle.

As the end user desires to expose to the view the characteristics of the beverage, then the label can also be withdrawn and affixed on the rear of the bottle.

It has been found that the invention fully achieves the indented aim and objects.

In fact, the invention provides a support device for labels, pictures, cards and the like which can be made of any desired material, shape, size, color and decoration and can be applied on bottles and vessels for beverages and liquid food materials, such as wine, liqueurs, oils, pasta, spices and so on, to allow the vessel to be customized for advertising, distinctive and celebrative purposes.

The bottles including the device according to the present invention have a decorative function and can be held in a full or empty condition on a book furniture piece, on a scaffold for kitchen or bathroom, depending on its contents, on a bar furniture piece, on a wine carriage and the like.

The bottles including the frame device according to the invention can represent collection articles: in fact, they can be reused as wine or liqueur vessels or, in a case of a removable label application, they can constitute an ornamental article, with picture and the like bearing function.

The frame device according to the present invention provides a lot of different commercial advantages.

In fact, said device can be used for enhancing selling events in wine shops with bottles which, owing to their distinctive packaging, would become collection articles, gift articles, to provide as a corporate gift or for any types of anniversary dates.

Moreover, the device according to the present invention can also be used for differently marking wines of a same maker.

The present device can be used in wine fitting markets, since it provides a customizing solution for customizing bottles and the like.

In practicing the invention, the used materials, as well as the contingent size and shapes, can be any, depending on requirements.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. A support device to be applied to a bottle, comprising a frame which can be applied to a surface of the bottle by removable clamping means and an information, decoration and image supported plate element wherein said plate element is adapted to be arranged between said frame and bottle surface to expose said information, decoration and image supported thereby.

16. A device according to claim 15, wherein said clamping mean comprise a biadhesive material.

17. A device according to claim 15, wherein said frame is made of a precious or non-precious metal material, a solid or laminated metal material, an easily formed material, a resin, ceramics, wood, paperboard, plastics or a glass material.

18. A device according to claim 15, wherein said frame comprises punching marks, embossed regions, incisions and decorations.

19. A device according to claim 15, wherein said frame has a conventional label frame which is either rectangular, square, oval, an enveloping shape, a creeping plan, a flower, a tie or papillon.

20. A apparatus, according to claim 15, wherein between said frame and bottle is arranged a casing made of a paperboard or semirigid plastic material, rigid with said frame, for facilitating an engaging therein of a sheet element, plate element, picture or card for protective purposes.

21. A device, according to claim 15, wherein for a curved cross-section bottle, the concave contour of said bottle provides it with a self bearing stability, which, if bottle is removable, allows said bottle to be used as an ornamental article.

22. A device according to claim 15, wherein, for a square cross-section bottle or a flat side bottle, a withdrawing fin mountable on said frame to provide a picture bearing casing is provided.

23. A device, according to claim 15, wherein said label can be removed by glueing or clamping it to adhesive materials or removable elements.

24. A device, according to claim 15, wherein said frame, or semirigid plastic material envelope is adapted to engage a label having information related to the contents of said bottle or a picture or a customizing card in said frame.

26. A device, according to claim 24, wherein said label can be withdrawn or removed and applied on a rear of said bottle.
